(19) United States
(12) Patent Application Publication
(10) Pub. No.: US 2014/0352550 A1
(43) Pub. Date: Dec. 4, 2014

(54) BAKING OVEN COMPRISING A CONTINUOUS BAKING BELT

(71) Applicant: HAAS FOOD EQUIPMENT GMBH, WIEN (AT)

(72) Inventors: Johannes Haas, Wien (AT); Josef Haas, Leobendorf (AT); Stefan Jiraschek, Koenigsbrunn (AT); Christoph Jirascheck, Frederiksberg (DK)

(73) Assignee: HAAS FOOD EQUIPMENT GMBH, Wien (AT)

(21) Appl. No.: 14/116,408

(22) PCT Filed: May 3, 2012
(86) PCT No.: PCT/EP2012/058137

§ 371 Date: Jun. 23, 2014

(30) Foreign Application Priority Data
May 11, 2011 (AT) A 667/2011

(51) Int. Cl. A21B 1/42; H05B 6/12; H05B 6/10

(52) U.S. Cl. CPC A21B 1/42; H05B 6/107; H05B 6/129
USPC 99/339

(57) ABSTRACT

A baking oven with a continuous baking belt and a belt preheating device has a front belt deflecting station, an input station, a baking chamber arranged in a housing, an output station and a rear belt deflecting station. The upper run of the baking belt extends from the front belt deflecting station through the baking chamber to the rear belt deflecting station. The lower run of the baking belt extends from the rear band deflecting station below the baking chamber to the front belt deflecting station. The belt preheating device is arranged on the circumferential path of the baking belt outside of the baking chamber. The baking belt is an inductively heated susceptor. The belt preheating device has an extensive inductor for inductively heating the baking belt moving past it to the belt preheating temperature by the extensive magnetic field generated by the inductor.

The invention relates to a baking oven comprising a continuous baking belt, which revolves in longitudinal direction of the baking oven, wherein a front belt deflecting station, an input station, a baking chamber, an output station and a rear belt deflecting station are arranged behind one another in longitudinal direction of the baking oven. The upper run of the baking belt is arranged in an upper transport plane and extends backwards from the front belt deflecting station through the input station, the baking chamber and through the output station to the rear belt deflecting station. The lower run of the baking belt extends forwards from the rear belt deflecting station below the baking chamber to the front belt deflecting station. The baking chamber is arranged in a housing, which is provided with an outer heat insulation and which is supported by an oven frame. The baking oven is provided with a belt preheating device, which is arranged on the circumferential path of the baking belt outside of the baking chamber.

Baking ovens, in the case of which a continuous baking belt revolves in longitudinal direction of the baking oven, are used in the food industry for producing all kinds of baked goods. Such baked goods are, e.g., flat cookies, crunchy crackers, but also small baked goods, cakes, breads, sandwich loaves, etc.

To produce the baked goods, pieces of dough, which consist of raw dough and which have already been brought into the form that corresponds to the respective baked goods, are fed to the baking oven. The pieces of dough are placed onto the baking belt at the input station and are conveyed into the baking chamber by means of the baking belt. The pieces of dough are baked in the baking chamber. The baking belt conveys the baked pieces of dough to the output station. In the output station, the baked pieces of dough are removed from the baking belt as completely baked goods.

Baking ovens, which are equipped with a belt preheating device, in which the revolving baking belt is heated before it reaches the input station of the baking oven, are used for the production of cookies and crackers. In the input station, the raw pieces of dough are placed onto the heated or preheated baking belt, respectively. The raw pieces of dough are heated by means of the preheated baking belt. The preheated pieces of dough are conveyed into the baking chamber of the baking oven by means of the baking belt and are subjected to high baking temperatures at that location.

Belt preheating devices, which are equipped with gas burners and which are arranged in the oven frame below the baking chamber and which are provided with a heat insulation at least on the upper side, are used in the case of known baking ovens for producing cookies and crackers. The heat insulation, which is arranged on the upper side of the belt preheating device, prevents the housing of the baking oven, which is arranged above the belt preheating device and which contains the baking chamber, is heated from below by the heat, which is generated in the belt preheating device. The baking belt is heated directly in the belt preheating device by means of the flue gases of the gas burners. The interior of the belt preheating device is filled with hot flue gases. The flue gases of the gas burners are discharged from the belt preheating device via lateral flue ducts.

It is the object of the invention to specify an improved baking oven, which has a continuous baking belt, which revolves in longitudinal direction of the baking oven and which is equipped with a belt preheating device.

As solution, the invention proposes a new baking oven. The latter is provided with a continuous baking belt, which revolves in longitudinal direction of the baking oven. In the case of the new baking oven, a front belt deflecting station, an input station, a baking chamber, an output station and a rear belt deflecting station are arranged behind one another in longitudinal direction of the baking oven. The upper run of the baking belt is arranged in an upper transport plane and extends backwards from the front belt deflecting station through the input station, the baking chamber and through the output station to the rear belt deflecting station. The lower run of the baking belt extends forwards from the rear belt deflecting station below the baking chamber to the front belt deflecting station. The baking chamber is arranged in a housing, which is provided with an outer heat insulation and which is supported by an oven frame. The new baking oven is provided with a belt preheating device, which is arranged on the circumferential path of the baking belt outside of the baking chamber.

According to the invention, the new baking oven is characterized by the following features. The baking belt is embodied as a susceptor, which can be heated inductively to the belt preheating temperature in a contactless manner. The baking oven has an inductive belt preheater, which is embodied as electrical induction heater. The inductive belt preheater has at least one extensive inductor, which is arranged in the belt preheating device and which is arranged adjacent to the baking belt and the baking belt, which passes it and which is embodied as a susceptor, is heated inductively to the belt preheating temperature in a contactless manner and thus generates the belt preheating by means of the extensive magnetic field generated by said inductor.

The baking oven according to the invention has a baking belt, which is embodied as a susceptor, which can be heated inductively in a contactless manner and which can be heated inductively to the relatively high belt preheating temperature. The belt preheating temperature is adjusted to the baking process, which is to be realized in the baking oven and is predetermined by it. In the belt preheating device, the baking belt is heated inductively to the relatively high belt preheating temperature. The belt temperature, which is generated inductively in the belt preheating device, is chosen to be very high, so that the inductively heated, hot baking belt arrives in the input station with a belt temperature, which is sufficient for heating the pieces of dough, which are placed onto the hot baking belt. The belt section of the baking belt, which is inductively heated in the belt preheating device, is conveyed to the input station of the baking oven by means of the revolving movement of the baking belt. There, the raw pieces of dough are placed onto the hot belt section and are heated slightly by the latter before they are conveyed into the baking chamber of the baking oven by means of the baking belt.

In the case of the embodiment of the baking oven according to the invention, the baking belt is heated inductively in a contactless manner in the belt preheating device and is thereby heated inductively to the relatively high belt preheating temperature. The inductive heating of the baking belt generates considerably lower room temperatures in the belt preheating device than does the heating of the baking belt by means of the flue gases of gas burners provided in the case of a conventional belt preheating device. In the case of the baking oven according to the invention, the heat insulation required at the outside of the belt preheating device can be reduced considerably and can thus be designed more cost efficiently than in the case of a conventional belt preheating device, which is equipped with gas burners.

In the case of the baking oven according to the invention, the electrical induction heater, which is provided for the belt preheating, can be embodied with a relatively high degree of efficiency (up to 0.79), which lies considerably above the degree of efficiency of a belt preheating by means of a gas burner (only 0.33).

The embodiment of the baking oven according to the invention allows it to considerably reduce the overall length of the belt preheating device, measured in longitudinal direction of the baking belt, as compared to a belt preheating device, which is equipped with gas burners, because the extensive inductor of the inductive belt preheater, which is arranged in the belt preheating device in the case of the baking oven according to the invention, requires a considerably shorter belt section for inductively heating the baking belt than does the belt preheating device, which is equipped with gas burners.

The baking belt of the baking oven according to the invention is embodied as a susceptor, which can be heated inductively in a contactless manner and which can be heated inductively to the relatively high belt preheating temperature. This susceptor belt can be embodied in different ways.

The susceptor belt can be embodied as a wire conveyor belt consisting of wire pieces, which has a high mass density. The wire conveyor belt can be embodied as a woven wire mesh belt, flat link belt, multi-spiral belt, etc. In the case of the susceptor belt, which is embodied as a wire conveyor belt, the wire pieces are arranged closely next to one another, the spaces between the wire pieces are small and the cross section of the wire pieces is relatively large. This leads to a high mass density of the wire conveyor belt. In the case of a susceptor belt, which is embodied as a wire conveyor belt, a minimum weight of 18 kg per each meter of belt length is preferred. The susceptor belt, which is embodied as a wire conveyor belt, can also encompass a higher belt weight than 18 kg per each meter of belt length.

The susceptor belt can also be embodied as a plate belt, which encompasses a high mass density. The plate belt can be embodied as a hinged plate belt or as a continuous steel plate belt, the steel plates of which are fastened to lateral transport chains. In the case of the susceptor belt, which is embodied as a plate belt, the high mass density is attained by means of the relatively large thickness of the plates, which consist of iron or steel, respectively. In the case of the susceptor belt, which is embodied as a plate belt, a minimum weight of 18 kg per each meter of belt length is preferred. The susceptor belt, which is embodied as a plate belt, can also encompass a higher belt weight of 20 kg and more for each meter of belt length.

According to a further feature of the invention, provision can be made for a lower belt preheating device to be provided, which is arranged on the lower run of the baking belt and in which an extensive inductor of the inductive belt preheater is arranged, which inductively heats the lower run of the baking belt, which moves past it, to the belt preheating temperature in a contactless manner and thus generates the belt preheating by means of the extensive magnetic field generated by said inductor.

According to a further feature of the invention, provision can be made for the lower belt preheating device, which is arranged on the lower run of the baking belt and which includes an extensive inductor of the inductive belt preheater, to be arranged below the input station of the baking oven.

According to a further feature of the invention, provision can be made for the lower belt preheating device, which is arranged on the lower run of the baking belt and which includes an extensive inductor of the inductive belt preheater, to be arranged in the oven frame below the baking chamber.

According to a further feature of the invention, provision can be made in the lower belt preheating device for an extensive inductor of the inductive belt preheater, which is arranged below the lower run of the baking belt and which inductively heats the lower run of the baking belt, which moves past the top of it, to the belt preheating temperature in a contactless manner and thus generates the belt preheating by means of the magnetic field generated by said inductor.

According to a further feature of the invention, provision can be made in the lower belt preheating device above the lower run of the baking belt for an extensive inductor of the inductive belt preheater to be arranged, which inductively heats the lower run of the baking belt, which moves past the bottom it, to the belt preheating temperature in a contactless manner and thus generates the belt preheating by means of the magnetic field generated by said inductor.

According to a further feature of the invention, provision can be made in the lower belt preheating device above and below the lower run of the baking belt for an extensive inductor of the inductive belt preheater, wherein the magnetic fields generated by the two inductors inductively heat the lower run of the baking belt, which passes between the inductors, to the belt preheating temperature in a contactless manner and thus generate the belt preheating.

According to a further feature of the invention, provision can be made in the lower belt preheating device for an extensive inductor of the inductive belt preheater, which is embodied in a C-shaped manner, which overlaps the lower run of the baking belt with horizontal sections on the upper side and the lower side and which inductively heats the lower run of the baking belt, which passes between its horizontal sections, to the belt preheating temperature in a contactless manner and thus generates the belt preheating.

According to a further feature of the invention, provision can be made in the lower belt preheating device for an extensive inductor of the inductive belt preheater, which overlaps the lower run of the baking belt and which has vertical sections, which are arranged laterally at a distance from the side edges of the baking belt and horizontal sections, which are adjacent to the upper side or the lower side, respectively, of the baking belt, wherein only the horizontal sections of the inductor inductively heat the lower run of the baking belt, which passes through the inductor, to the belt preheating temperature in a contactless manner and thus generate the belt preheating by means of the magnetic fields generated by said inductor.

According to a further feature of the invention, provision can be made for an upper belt preheating device to be provided, which is arranged adjacent to the section of the baking belt arranged in the input station and in which an extensive inductor of the inductive belt preheater is arranged, which inductively heats the baking belt, which is embodied as a susceptor, to the belt preheating temperature in a contactless manner and thus generates the belt preheating by means of the magnetic field generated by said inductor.

According to a further feature of the invention, provision can be made for the upper belt preheating device to include an extensive inductor of the inductive belt preheater, which is arranged below the baking belt and which inductively heats the baking belt, which is embodied as a susceptor and which moves past it on the top, to the belt preheating temperature in a contactless manner and thus generates the belt preheating by means of the magnetic field generated by said inductor.

According to a further feature of the invention, provision can be made for the baking belt, which is embodied as a susceptor and which can be heated inductively to the belt preheating temperature in a contactless manner by means of an electrical induction heater, to be a heavy baking belt comprising a high mass density, chosen from the group: (1) wire conveyor belts, (2) woven wire mesh belts, (3) round link belts, (4) multi-spiral belts, (5) flat link belts, and (6) hinged plate belts.

The invention will be defined in more detail below by means of exemplary embodiments illustrated in the drawings.

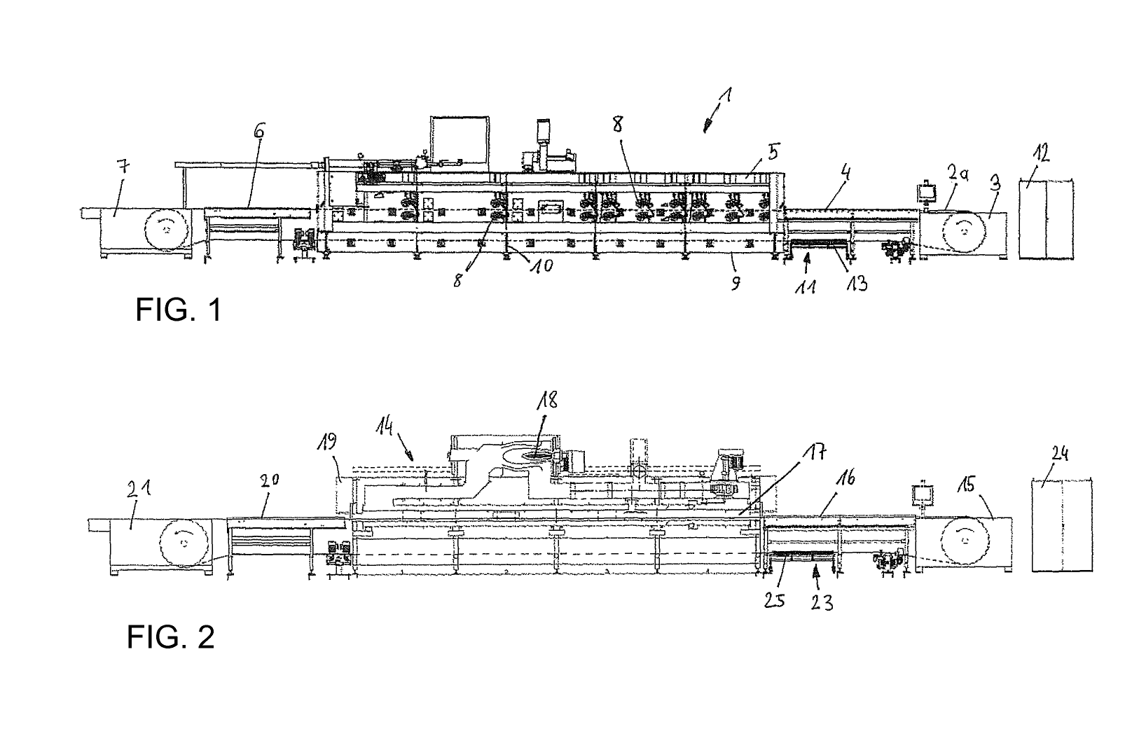

FIG. 1 shows a baking oven from the side,

FIG. 2 shows a further baking oven from the side,

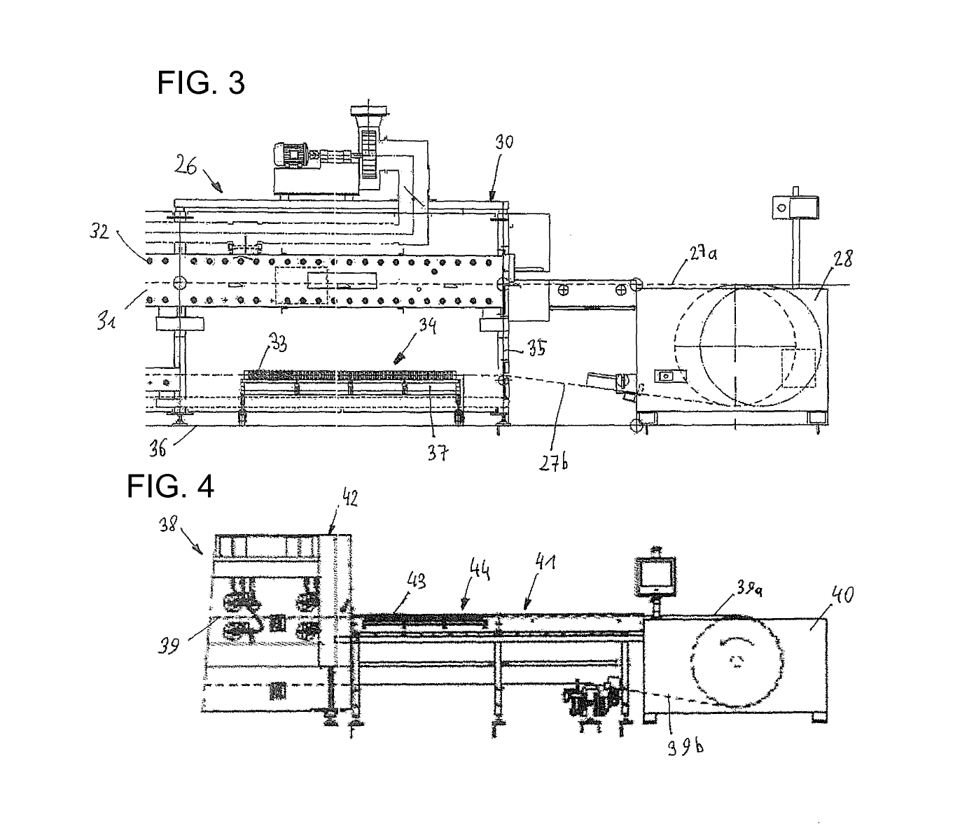

FIG. 3 shows a third baking oven from the side,

FIG. 4 shows a fourth baking oven from the side,

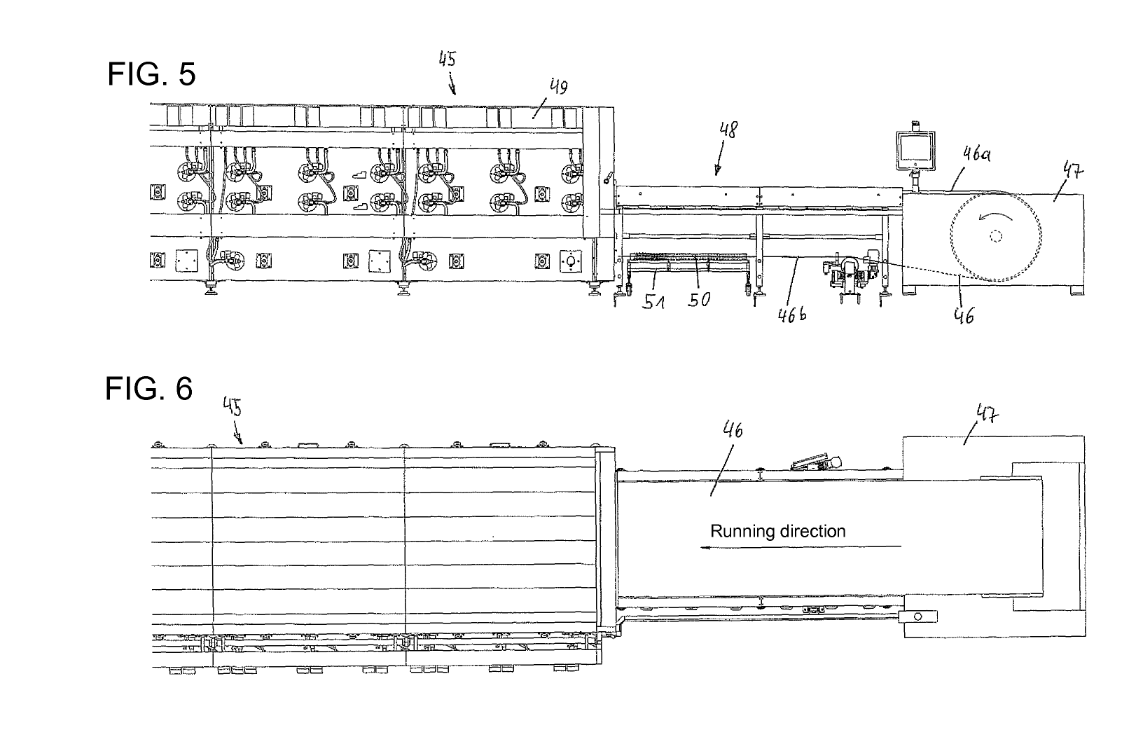

FIG. 5 shows a fifth baking oven from the side,

FIG. 6 shows a top view onto the baking oven of FIG. 5,

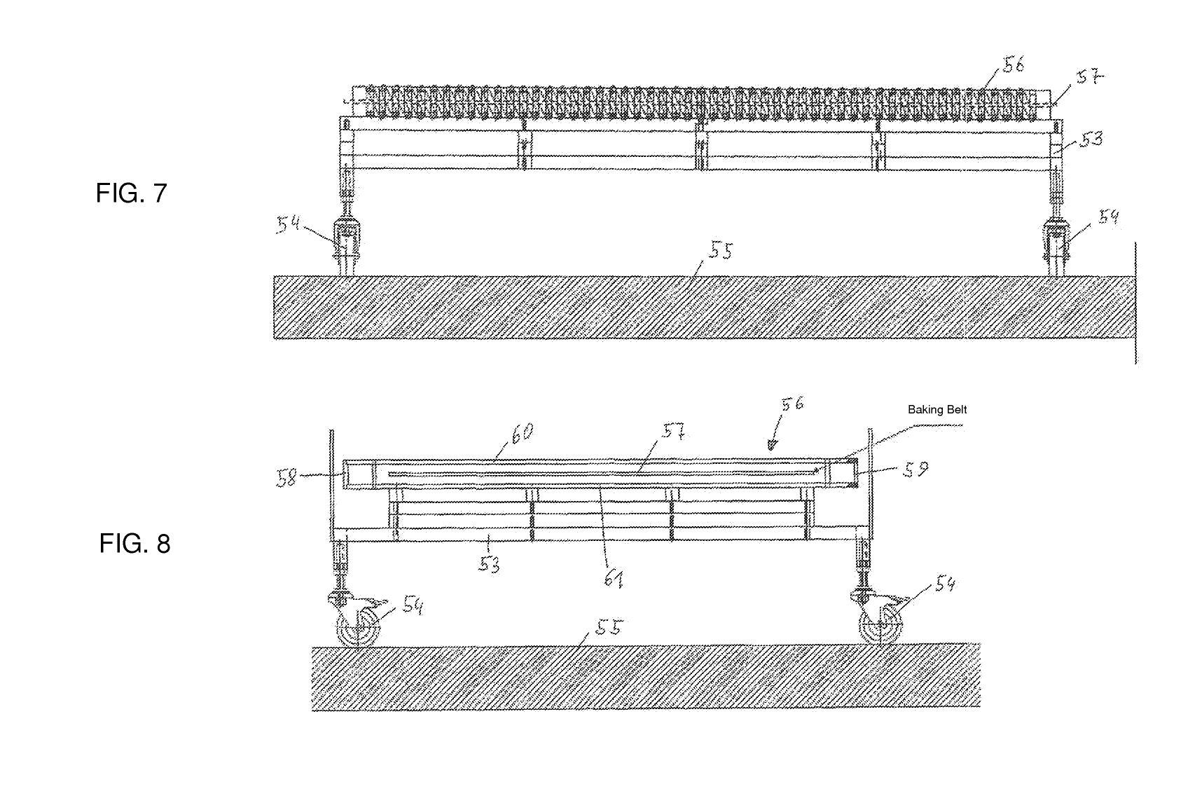

FIG. 7 shows a first belt preheating device with inductor in side view,

FIG. 8 shows the belt preheating device of FIG. 7 in frontal view,

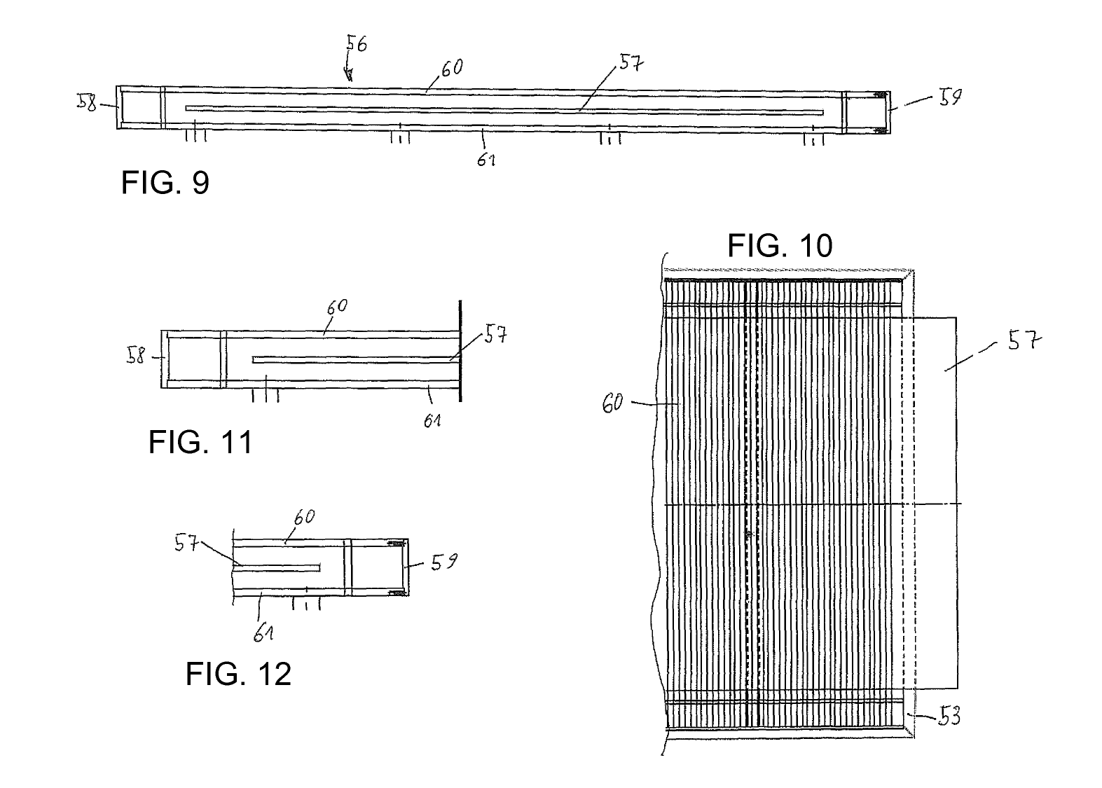

FIG. 9 shows the inductor of the belt preheating device of FIG. 7 in frontal view,

FIG. 10 shows a part of the inductor of FIG. 9 from the top,

FIG. 11 shows the left end section of the inductor of FIG. 9,

FIG. 12 shows the right end section of the inductor of FIG. 9,

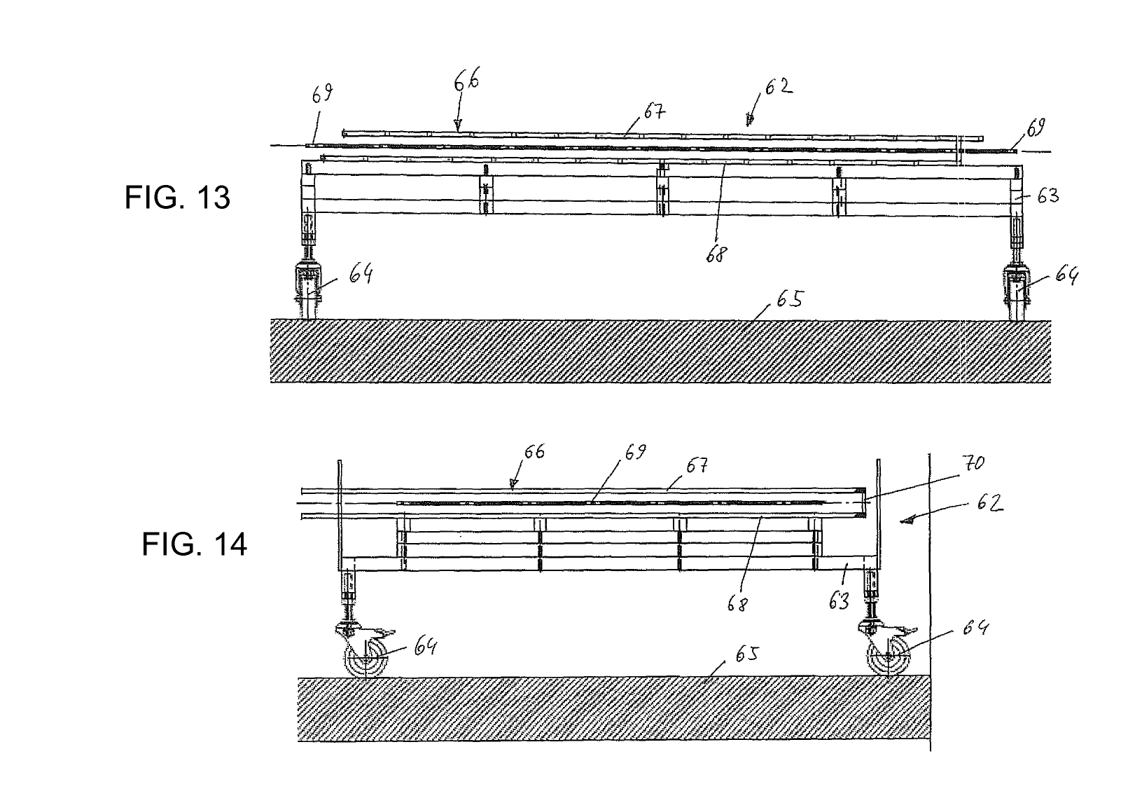

FIG. 13 shows a second belt preheating device of the inductor in side view,

FIG. 14 shows the belt preheating device of FIG. 13 in frontal view,

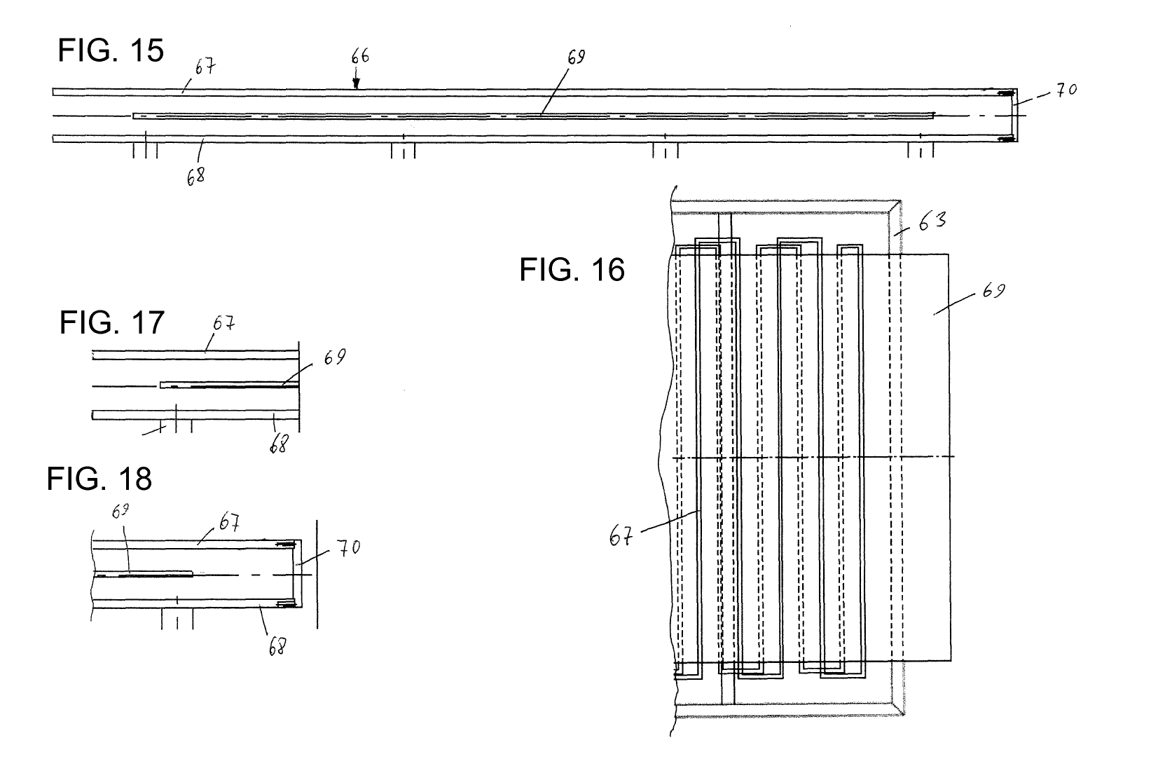

FIG. 15 shows the inductor of the belt preheating device of FIG. 13 in frontal view,

FIG. 16 shows a part of the inductor of FIG. 15 from the top,

FIG. 17 shows the left end section of the inductor of FIG. 15, and

FIG. 18 shows the right end section of the inductor of FIG. 15.

FIG. 1 shows a baking oven 1 comprising a continuous baking belt 2. In this baking oven 1, a front belt deflecting station 3, which is arranged at the front end thereof, furthermore an input station 4 and an elongated housing 5, which includes the baking chamber of the baking oven 1, furthermore an output station 6 and a rear belt deflecting station 7, which is arranged on the rear end of the baking oven 1, are arranged behind one another in longitudinal direction of the baking oven 1.

The continuous belt 2 revolves in the baking oven 1 in the longitudinal direction thereof. The upper run 2a of the baking belt 2 is arranged in an upper transport plane and moves in the latter from the front belt deflecting station 3 to the input station 4 and then through the input station 3, through the baking chamber arranged in the housing 5 and through the output station 6 to the rear belt deflecting station 7 of the baking oven 1. The lower run 2b of the baking belt 2, which is arranged below the upper run 2a, moves back towards the front from the rear belt deflecting station 4 of the baking oven 1 to the front belt deflecting station 3 of the baking oven 1.

The baking chamber and the baking chamber heater of the baking oven 1, which encompasses a plurality of heating elements 8, are accommodated in the elongated housing 5. The housing 5 is provided with an outer heat insulation, which extends across the entire length of the housing 5. The housing 5 is supported by the oven frame 9 of the baking oven 1. The oven frame 9 has vertical feet 10, which support the housing 5 on the ground at the set-up location of the baking oven 1. The feet 10 are arranged on the side edges of the housing 5 and form two rows of feet, which run in longitudinal direction of the baking oven 1. The lower run 2b of the baking belt 2 is arranged below the housing 1 between the two rows of feet.

During the operation of the baking oven 1, the continuous baking belt 2 revolves in longitudinal direction of the baking oven 1. In the input station 4, raw pieces of dough are placed onto the upper run 2a of the baking belt 2 and are conveyed through the baking chamber arranged in the housing 5 by means of the baking belt 2. The pieces of dough are baked in the baking chamber. The revolving baking belt 2 conveys the baked pieces of dough to the output station 6 of the baking oven 1. In the output station 6, the baked pieces of dough are removed from the baking belt 2 as completely baked goods.

The baking oven 1 has a belt preheating device 11, which is arranged on the circumferential path of the baking belt 2 and in which the baking belt 2, which passes this device 11, is heated to a relatively high belt temperature, so that the baking belt 2 arrives at the input station 4 in the heated state, in which the raw pieces of dough are then placed onto the already heated, hot baking belt 2 and are subsequently heated by means of the hot baking belt 2. The pieces of dough, which have been heated by the hot baking belt 2, but which are still raw, are conveyed into the baking chamber, which has been heated to high baking temperatures by means of the baking chamber heater of the baking oven 1, by means of the hot baking belt 2. The pieces of dough preheated on the hot baking belt 2 are baked completely while passing through the baking chamber. The baked pieces of dough are then removed from the upper run 2a of the baking belt 2 as completely baked goods at the output station 6. Baked goods, which are identified as crackers or hard cookies, e.g., can thus be produced in the baking oven 1.

The baking oven 1 has a lower belt preheating device 11, which is assigned to the lower run 2b of the baking belt 2. Said preheating device 11 is arranged on the front side of the housing 5 in the space between the front belt deflecting station 3 and the housing 5 and heats the baking belt 2 at its lower run 2b. The heated, hot belt section of the baking belt 2 passes the front belt deflecting station 3 and is conveyed into the input station 4 by means of the revolving movement of the baking belt 2.

The baking belt 2 of the baking oven 1 is embodied as a continuous susceptor belt, which can be heated inductively to high belt temperatures in a contactless manner by means of an electrical induction heater in a contactless manner, which can be heated inductively to high belt temperatures.

The baking oven 1 is equipped with an inductive belt preheater, which is embodied as an electrical induction heater. The electrical induction heater provides for an alternating current generator 12, which is connected via current lines to an extensive inductor 13, which is arranged in the lower belt preheating device 11 and which inductively heats the lower run 2b of the baking belt 2 in a contactless manner by means of the extensive magnetic field generated by said inductor. The baking belt 2 is heated inductively to high belt temperatures in the lower belt preheating device 11. The high belt temperatures are in the range of the relatively high belt preheating temperatures from xx to yy degrees Celsius, which are predetermined by a cracker baking process, e.g.

FIG. 2 shows a further baking oven 14 according to the invention, the constructive design of which largely corresponds to the baking oven 1 of FIG. 1.

In the case of the baking oven 14, a front belt deflecting station 15, an input station 16, an elongated housing 19, which includes the baking chamber 17 and the baking chamber heater 18, an output station 20 and a rear belt deflecting station 21 are arranged behind one another in longitudinal direction. The baking oven 14 has a continuous baking belt 22, which revolves in longitudinal direction of the baking oven 14 from the front belt deflecting station 15 to the rear belt deflecting station 21. The upper run of the baking belt 22 is arranged in an upper transport plane and moves therein from the front belt deflecting station 15 to the input station 16 and then through the input station 16, through the baking chamber 17 arranged in the housing 19 and through the output station 20 to the rear belt deflecting station 21.

The baking oven 14 has a lower belt preheating device 23, which is arranged between the front belt deflecting station 15 and the housing 19. The revolving baking belt 22 passes the lower belt preheating device 23 with its lower run 22b and is heated there to high belt temperatures. The hot belt section of the revolving baking belt 22, which has been heated in the lower belt preheating device 23, passes the front belt deflecting station 15 and is conveyed into the input station 16 by means of the revolving movement of the baking belt 22.

The baking belt 22 is embodied as a continuous susceptor belt, which can be heated inductively to high belt temperatures in a contactless manner by means of an electrical induction heater in a contactless manner and can be heated inductively to high belt temperatures.

The baking oven 14 is equipped with an inductive belt preheater, which is embodied as electrical induction heater. The electrical induction heater provides for an alternating current generator 24, which is connected via current lines to an extensive inductor 25, which is arranged in the lower belt preheating device 23 and which inductively heats the baking belt 22 in a contactless manner by means of the extensive magnetic field generated by said inductor. The inductor 25 or the magnetic field generated by it, respectively, heats the baking belt 22 inductively to high belt temperatures in a contactless manner. The high belt temperatures, which are generated in the baking belt 22 by the electrical induction heater via the inductor 25 are in the range of the relatively high belt preheating temperatures from xx to yy degrees Celsius, which are predetermined by a cracker baking process, e.g.

FIG. 3 shows a further baking oven 26 according to the invention. The front section of the baking oven 26 is illustrated in FIG. 3. The baking oven 26 has a continuous baking belt 27, which revolves in the longitudinal direction thereof, comprising an upper run 27a and a lower run 27b. The baking oven 26 has a front belt deflecting station 28, an input station 29 and an elongated housing 30, which connects to the input station 29 and in which the baking chamber 31 and the baking chamber heater 32 are accommodated.

The baking belt 27 is embodied as a continuous susceptor belt, which can be heated inductively to high belt temperatures in a contactless manner by means of an electrical induction heater.

The baking oven 26 is equipped with an inductive belt preheater, which is embodied as an electrical induction heater. The alternating current generator of the induction heater is connected to an extensive inductor 33 via current lines. The inductor 33 is arranged in a belt preheating device 34, which is arranged in the oven frame 35 below the housing 30 on the lower belt section of the circumferential path of the baking belt 27. The belt preheating device 34 extends along the lower run 27b of the baking belt 27. It has a support frame 37 supported on the bottom 36, which supports the inductor 33, which is fastened to the support frame 37 so as to be electrically insulated. The inductor 33 is arranged adjacent to the lower run 27b of the baking belt 27. The lower run 27b of the revolving baking belt 27 passes the extensive magnetic field generated by the inductor 33 and is thereby heated inductively to a high belt temperature in a contactless manner by means of this magnetic field.

FIG. 4 shows a further baking oven 38 according to the invention. The front section of the baking oven 38 is illustrated in FIG. 4. The baking oven 38 has a continuous baking belt 39, which revolves in the longitudinal direction thereof, comprising an upper run 39a and a lower run 39b. The baking oven 38 has a front belt deflecting station 40, an input station 41 and an elongated housing 42, which connects to the input station 41 and in which the baking chamber and the baking chamber heater of the baking oven 38 are accommodated.

The baking belt 39 is embodied as a continuous susceptor belt, which can be heated inductively to high belt temperatures in a contactless manner by means of an electrical induction heater in a contactless manner and which can be heated inductively to high belt temperatures.

The baking oven 38 is equipped with an inductive belt preheater, which is embodied as an electrical induction heater. The alternating current generator of the induction heater is connected to an extensive inductor 43 via current lines. The inductor 43 is arranged in an upper belt preheating device 44, which is arranged in the input station 41 of the baking oven 38 adjacent to the upper run 39a of the baking belt 39. The upper run 39a of the baking belt 39 passes the extensive magnetic field generated by the inductor 43 and is thereby heated inductively to a high belt temperature in a contactless manner by means of this magnetic field.

FIGS. 5 and 6 show a further baking oven 45 according to the invention. FIG. 5 shows a side view of the baking oven 45 and FIG. 6 shows a top view onto the baking oven 45. The front section of the baking oven 45 is illustrated in FIGS. 5 and 6. It has a continuous baking belt 46, which revolves in its longitudinal direction, comprising an upper run 46a and a lower run 46b. The baking oven 45 has a front belt deflecting station 47, an input station 48 and an elongated housing 49, which connects to the input station 48 and in which the baking chamber and the baking chamber heater are accommodated.

The baking belt 46 is embodied as a continuous susceptor belt, which can be heated inductively to high belt temperatures in a contactless manner by means of an electrical induction heater.

The baking oven 45 is equipped with an inductive belt preheater, which is embodied as an electrical induction heater. The alternating current generator of the induction heater is connected via current lines to an extensive inductor 50, which is arranged in a lower belt preheating device 51, which is arranged between the front belt deflecting station 47 and the housing 49. The revolving baking belt 46 passes the lower belt preheating device 51 with its lower run 46b and is heated inductively at that location to a high belt temperature in a contactless manner by means of the extensive magnetic field generated by the inductor 50.

FIGS. 7-12 show an embodiment of a lower belt preheating device 52 for a baking oven according to the invention. The belt preheating device 52 has a support frame 53, which is supported via wheels 54 on the bottom 55, on which the baking oven stands. An extensive inductor 56, which is fastened to the support frame 53 so as to be electrically insulated, is arranged on the upper side of the support frame 53. The inductor 56 is connected via current lines to an alternating current generator located outside of the belt preheating device 52 of an electrical induction heater, which is designed as an inductive belt preheater for the baking oven. The inductor 56 is embodied as an electrical induction coil, which has substantially rectangular windings, which encompass the flat baking belt 57 and which are arranged behind one another at a distance in longitudinal direction of the baking belt 57. The inductor 56 has vertical sections 58, 59, which are arranged laterally at a distance from the side edges of the baking belt 57 and horizontal sections 60, 61, which are adjacent to the upper side or the lower side, respectively, of the baking belt 57. The baking belt 57, which passes through the inductor 56, is heated inductively in a contactless manner by means of the magnetic fields generated by the horizontal sections 60, 61 of the inductor. The lateral distances of the vertical sections 58, 59 of the inductor from the side edges of the baking belt 57 are quite large. The magnetic fields generated by the vertical sections 58, 59 of the inductor do not lead to a noteworthy heating of the side edges of the baking belt 57.

FIGS. 13-18 show a further embodiment of a lower belt preheating device 62 for a baking oven according to the invention. This belt preheating device 62, too, has a support frame 63, which is supported via edges supported via wheels 64 on the bottom 65, on which the baking oven stands. An extensive, substantially C-shaped inductor 66, which is fastened to the support frame 63 so as to be electrically insulated, is arranged on the upper side of the support frame 63. The inductor 66 has an upper and a lower horizontal section 67, 68, with which the inductor 66 overlaps the flat baking belt 69 of the baking oven on the upper side or on the lower side, respectively. On the right side edge of the inductor 66, the upper horizontal section 67 of the inductor 66 is connected to the lower, horizontal section 68 of the inductor 66 by means of a vertical section 70 of the inductor 66. The left side edge of the inductor 66 is embodied so as to be open. The two horizontal sections 67, 68 of the inductor 66 are in each case embodied as a flat electrical induction coil.

1-12. (canceled)

13. A baking oven, comprising:
a continuous baking belt disposed to revolve in a longitudinal direction of the baking oven, said baking belt being a susceptor configured for inductive preheating;
a front belt deflecting station, an input station, a baking chamber, an output station and a rear belt deflecting station disposed in sequence one behind another in the longitudinal direction of the baking oven;
said baking belt having an upper run disposed in an upper transport plane and extending backwards from said front belt deflecting station through said input station, said baking chamber and through said output station to said rear belt deflecting station, and a lower run extending forward from said rear belt deflecting station below said baking chamber to said front belt deflecting station;
said baking chamber being formed in a housing, said housing having an outer heat insulation and being supported by an oven frame;
a belt preheating device disposed along a circumferential path of said baking belt outside of said baking chamber, said belt preheating device including an electrical induction belt preheater with at least one extensive inductor in said belt preheating device and adjacent said baking belt, wherein said baking belt, upon passing by said at least one inductor is inductively and contactlessly heated to a belt preheating temperature and wherein said inductor generates an extensive magnetic field for preheating said baking belt.

14. The baking oven according to claim 13, wherein said preheating device is a lower belt preheating device arranged at the lower run of said baking belt and including said extensive inductor of said inductive belt preheater disposed to inductively and contactlessly heat the lower run of said baking belt, upon moving past, to a belt preheating temperature and to effect belt preheating by way of the extensive magnetic field generated by said inductor.

15. The baking oven according to claim 14, wherein said lower belt preheating device is disposed below said input station of the baking oven.

16. The baking oven according to claim 14, wherein said lower belt preheating device is arranged in said oven frame below said baking chamber.

17. The baking oven according to claim 14, wherein said lower belt preheating device has said extensive inductor of said inductive belt preheater disposed below the lower run of said baking belt, for inductively heating the lower run of said baking belt, upon moving past, to the belt preheating temperature in a contactless manner and thus effecting the belt preheating by the magnetic field generated by said inductor.

18. The baking oven according to claim 14, wherein said extensive inductor of said inductive belt preheater is disposed in said lower belt preheating device above the lower run of said baking belt, for inductively heating the lower run of said baking belt, upon moving past below said inductor, to the belt preheating temperature in a contactless manner and thus effecting the belt preheating by the magnetic field generated by said inductor.

19. The baking oven according to claim 14, wherein said lower belt preheating device comprises an extensive inductor disposed above and an extensive inductor disposed below the lower run of said baking belt, for inductively heating the lower run of said baking belt, upon moving past said extensive inductors disposed above and below, respectively, wherein the magnetic fields generated by said inductors inductively heat the lower run of the baking belt to the belt preheating temperature in a contactless manner.

20. The baking oven according to claim 14, wherein said extensive inductor of said lower belt preheating device is a C-shaped extensive inductor disposed to overlap the lower run of said baking belt with horizontal sections above and below said baking belt, and wherein said inductor inductively heats the lower run of said baking belt, upon passing between said horizontal sections thereof, to a belt preheating temperature in a contactless manner.

21. The baking oven according to claim 14, wherein said extensive inductor in said lower belt preheating device is disposed to overlap the lower run of said baking belt and said inductor is formed with vertical sections arranged laterally at a spacing distance from side edges of said baking belt and with horizontal sections, which are in each case adjacent to an upper side or a lower side, respectively, of said baking belt, wherein only said horizontal sections of said inductor inductively heat the lower run of said baking belt, upon running through said inductor, to the belt preheating temperature in a contactless manner and thus effect belt preheating by a magnetic field generated by said inductor.

22. The baking oven according to claim 13, wherein said preheating device is an upper belt preheating device disposed adjacent a section of said baking belt arranged in said input station and having said extensive inductor of said inductive belt preheater disposed therein and configured to inductively and contactlessly heat said baking belt to a belt preheating temperature and thus to effect belt preheating by way of a magnetic field generated by said inductor.

23. The baking oven according to claim 22, wherein said extensive inductor of said inductive belt preheater of said upper belt preheating device is disposed below said baking belt and configured to inductively and contactlessly heat said baking belt, which is embodied as a susceptor, to a belt preheating temperature and thus to effect the belt preheating by way of the magnetic field generated by said inductor.

24. The baking oven according to claim 13, wherein said baking belt that is embodied as a susceptor for inductive and contactless heating to the belt preheating temperature by said electrical induction heater, is a heavy baking belt with a high mass density selected from the group consisting of: wire conveyor belts, woven wire mesh belts, round link belts, multi-spiral belts, flat link belts, and hinged plate belts.
